(19) United States
(12) Patent Application Publication
(10) Pub. No.: US 2013/0212107 A1
(43) Pub. Date: Aug. 15, 2013

(54) INFORMATION PROCESSING APPARATUS AND CONTROL METHOD THEREOF

(71) Applicant: CANON KABUSHIKI KAISHA, (US)

(72) Inventor: Yumiko Uchida, Kunitachi-shi (JP)

(73) Assignee: CANON KABUSHIKI KAISHA, Tokyo (JP)

(21) Appl. No.: 13/747,195

(22) Filed: Jan. 22, 2013

(30) Foreign Application Priority Data
Feb. 13, 2012 (JP) 2012-028859

(51) Int. Cl. G06F 17/30

(52) U.S. Cl. CPC G06F 17/30321
USPC 707/739

(57) ABSTRACT

Enlargement values indicating a degree of enlargement when spatial data is stored in a partial spatial region are calculated for one or more partial spatial regions within a multidimensional index, and in the case where the enlargement value is greater than or equal to a threshold value, a new partial spatial region that contains at least the spatial data is generated.

### BACKGROUND OF THE INVENTION

1. Field of the Invention

The present invention relates to multidimensional indexing techniques that speed up searches of multidimensional data such as image capture position information in photographs.

2. Description of the Related Art

Recent years have seen an increase in cameras that include GPS (Global Positioning System) functionality, and it has thus become possible to add geographical information, in which the latitude/longitude of the location where an image was captured is recorded, to photograph data. At the same time, photo viewing applications in cameras, PCs, and the like are increasingly being provided with functionality for using the geographical information of the capture location of photograph data to search photograph data captured within a given region and display that capture location in association with a position on the map.

The geographical information of the capture location is multidimensional data configured of a latitude, a longitude, an elevation, and so on. For this reason, index structures designed for one-dimensional data are not suitable for use in geographical information searches. The reason for this is that with a one-dimensional index such as a B-Tree, pieces of data in spatially close locations cannot be disposed near each other in the index, and thus a significant drop in performance can occur depending on the search query.

Generally, R-Trees are used as indexes suited for searching multidimensional data such as geographical information (such indexes are collectively called multidimensional indexes or spatial indexes). An R-Tree is a technique for forming a tree-structure index by dividing a multidimensional space according to rectangular partial spatial regions that have been inserted hierarchically. An R-Tree is designed so that elements that are near each other in a space belong, to the greatest extent possible, to the same partial spatial region (that is, a node within the index). R-Trees are n-ary trees, and thus the size of intermediate nodes can be changed in accordance with the input/output sizes of the filesystem. This makes exchange with two-dimensional storage apparatuses efficient, and thus R-Trees are employed in many database systems.

Japanese Patent Laid-Open No. 2011-81554 and Japanese Patent Laid-Open No. 2000-357168 disclose related art regarding the improvement of multidimensional index systems that resemble R-Trees.

Japanese Patent Laid-Open No. 2011-81554 discloses a multidimensional index system that divides a multidimensional space into rectangular and spherical logical AND regions, where node sizes are reduced by manipulating the arrangement of spherical spatial regions, reducing the index size as a result.

Meanwhile, Japanese Patent Laid-Open No. 2000-357168 discloses a multidimensional index system that divides a multidimensional space into spherical regions, where node sizes are reduced by coding representations of the spheres within the index, reducing the index size.

In this related art, the number of disk accesses during a search can be reduced by reducing the index size, which makes it possible to accelerate the search process.

However, R-Trees have an issue in that the partial spatial regions cannot be properly generated depending on the laterality, registration order, and so on of the spatial data. In particular, in the case where only a small number of spatial data are located at a distance from other spatial data groups, there are situations where pieces of data whose locations are distant within the space will belong to the same partial spatial region. In such a case, the number of empty regions within the partial spatial region that are originally unnecessary will increase.

When executing a search using an R-Tree, it is necessary to perform a process for checking whether or not the search conditions match for all of the data within the partial spatial regions that overlap with the search region specified by the user. It is therefore desirable for each partial spatial region to have the minimum size that is necessary. If empty regions increase within the partial spatial regions, it is highly likely that the search region and the partial spatial regions will overlap even if no data is present within the search region, which will result in a wasteful search process. Accordingly, an increase in empty regions within partial spatial regions causes a drop in the search performance.

Although both of the aforementioned related art documents speed up searches by reducing the size of a multidimensional index, neither of these documents deals with the division of the partial spatial regions. Accordingly, with the aforementioned related art, in the case where only a small number of spatial data are located at a distance from other spatial data groups, a large number of empty regions will be produced in the partial spatial regions, causing a drop in the search performance.

### SUMMARY OF THE INVENTION

The present invention provides a multidimensional indexing technique that reduces empty regions within a partial spatial region by managing data whose locations are distant in a space as separate partial spatial regions, and thus reduces the number of partial spatial regions that overlap with a search region.

In one of aspect of the embodiment, an information processing apparatus according to the present invention is configured as follows. That is, the information processing apparatus executes a multidimensional indexing process that divides a multidimensional space into partial spatial regions, stores the partial spatial regions in nodes, and when registering spatial data, enlarges the partial spatial regions to contain the spatial data, and includes: an input unit configured to input spatial data configured of points or spatial regions into a multidimensional index that is constructed within a storage apparatus; a calculation unit configured to calculate enlargement values, for one or more partial spatial regions in the nodes of the multidimensional index, for the case where the spatial data is stored; a selection unit configured to select, from among the partial spatial regions whose enlargement values have been calculated by the calculation unit, a partial spatial region to serve as a storage destination candidate of the spatial data; and a generation unit configured to generate a new partial spatial region that contains at least the spatial data in the case where the enlargement value for the storage destination candidate partial spatial region selected by the selection unit is greater than or equal to a threshold.

According to the present invention, empty regions are reduced in partial spatial regions even in the case where a small number of spatial data are present in a location that is distanced from other spatial data groups, which makes it possible to reduce the number of partial spatial regions that overlap with a search region; this in turn makes it possible to carry out searches quickly.

Further features of the present invention will become apparent from the following description of exemplary embodiments (with reference to the attached drawings).

### BRIEF DESCRIPTION OF THE DRAWINGS

FIG. 1A is a block diagram illustrating an information processing apparatus that implements a multidimensional indexing process according to a first embodiment.

FIG. 1B is a block diagram illustrating the configuration of a data processing section according to the first embodiment.

FIG. 2A is a diagram illustrating the configuration of an image management table according to the first embodiment.

FIG. 2B is a schematic diagram illustrating the data structure of an image capture position index according to the first embodiment.

FIG. 3A is a schematic diagram illustrating a spatial division system according to the first embodiment.

FIG. 3B is a schematic diagram illustrating a spatial division system according to the first embodiment.

FIG. 4 is a schematic diagram illustrating the spatial division system according to the first embodiment.

FIG. 5A is a schematic diagram illustrating an R-Tree spatial division system.

FIG. 5B is a schematic diagram illustrating the R-Tree spatial division system.

FIG. 6A is a schematic diagram illustrating the spatial division system according to the first embodiment.

FIG. 6B is a schematic diagram illustrating the spatial division system according to the first embodiment.

FIG. 7 is a flowchart illustrating a registration process according to the first embodiment.

FIG. 8 is a flowchart illustrating a spatial data input process according to the first embodiment.

FIG. 9 is a flowchart illustrating a storage destination node selection process according to the first embodiment.

FIG. 10 is a flowchart illustrating an entry storage process according to the first embodiment.

FIG. 11 is a flowchart illustrating a tree adjustment process according to the first embodiment.

FIG. 12 is a flowchart illustrating a search process according to the first embodiment.

FIG. 13 is a flowchart illustrating a storage destination node selection process according to a second embodiment.

### DESCRIPTION OF THE EMBODIMENTS

Hereinafter, embodiments of the present invention will be described in detail using the drawings.

### First Embodiment

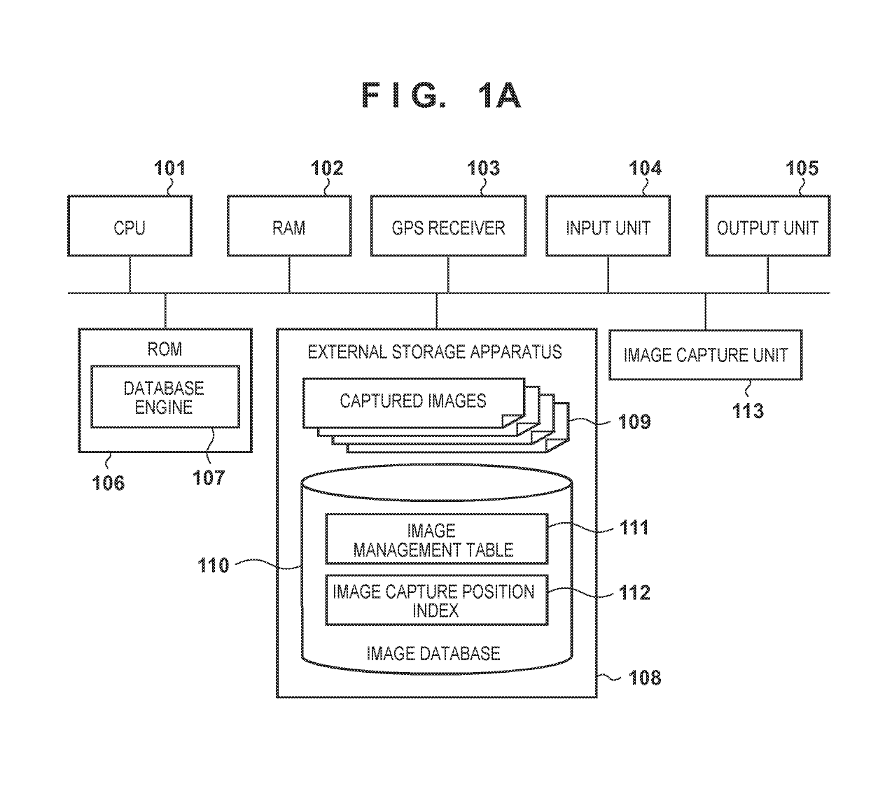

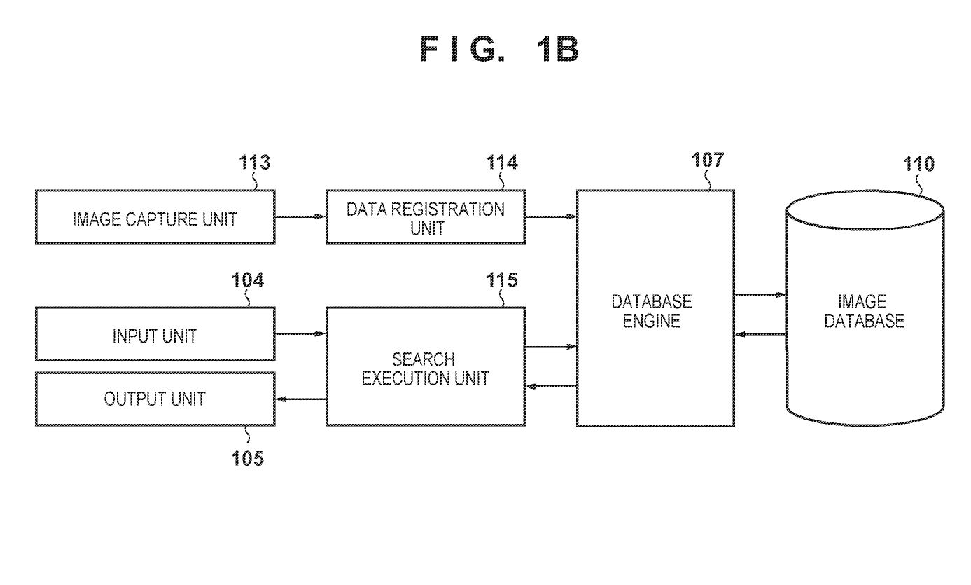

FIG. 1A is a block diagram illustrating an information processing apparatus that implements a multidimensional indexing process according to a first embodiment.

A CPU 101 controls the apparatus as a whole by executing control programs stored in a ROM 106. The ROM 106 stores programs executed by the CPU 101. By the CPU 101 executing programs, the apparatus functions as various types of constituent elements for executing various processes indicated in the flowcharts mentioned later. For example, a database engine 107 can be stored, and data can then be registered/searched. A RAM 102 temporarily stores various types of data from the various constituent elements. The RAM 102 also expands programs, which are then executed by the CPU 101.

An external storage apparatus 108 is an apparatus that stores data to be processed. A flash memory, an HDD, or the like can be used as the external storage apparatus 108. An image database 110 is present in the external storage apparatus 108, and an image management table 111 manages metadata that has been added to captured images 109. An image capture position index 112 is constructed for image capture position information stored in the image management table 111.

An image capture unit 113 is configured of components such as an optical apparatus, an image sensor, and so on, and captures an image of a subject in response to an instruction from the CPU 101. Image capturing results obtained by the image capture unit 113 are stored in the external storage apparatus 108 as the captured images 109.

A GPS receiver 103 receives signals from a GPS satellite, and measures the current position of the apparatus. When the image capture unit 113 captures an image, the image capture position information can be stored in association with the captured images 109 using the functionality of the GPS receiver 103.

An input unit 104 is configured of an input device such as operational buttons, a touch panel, or the like, and accepts instructions from a user. An output unit 105 is configured of an output device such as a liquid-crystal panel or the like, and displays data that is the target of processing in the present invention.

Although in the first embodiment, the processes corresponding to the various steps in the flowcharts mentioned later are realized through software using the CPU 101, it should be noted that some or all of those processes may be realized through hardware such as electronic circuits or the like.

FIG. 1B is a block diagram illustrating the configuration of a data processing section according to the first embodiment.

A data registration unit 114 receives the metadata of the captured images 109 from the image capture unit 113 and registers that metadata in the image database 110 via the database engine 107. A search execution unit 115 receives a user instruction from the input unit 104, and executes a search of the image database 110 via the database engine 107. A search result obtained by the search execution unit 115 is displayed in the output unit 105.

Although the data registration unit 114 and the search execution unit 115 may be realized, for example, as software using the CPU 101, it should be noted that some or all of those processes may be realized through hardware, such as electronic circuits or the like.

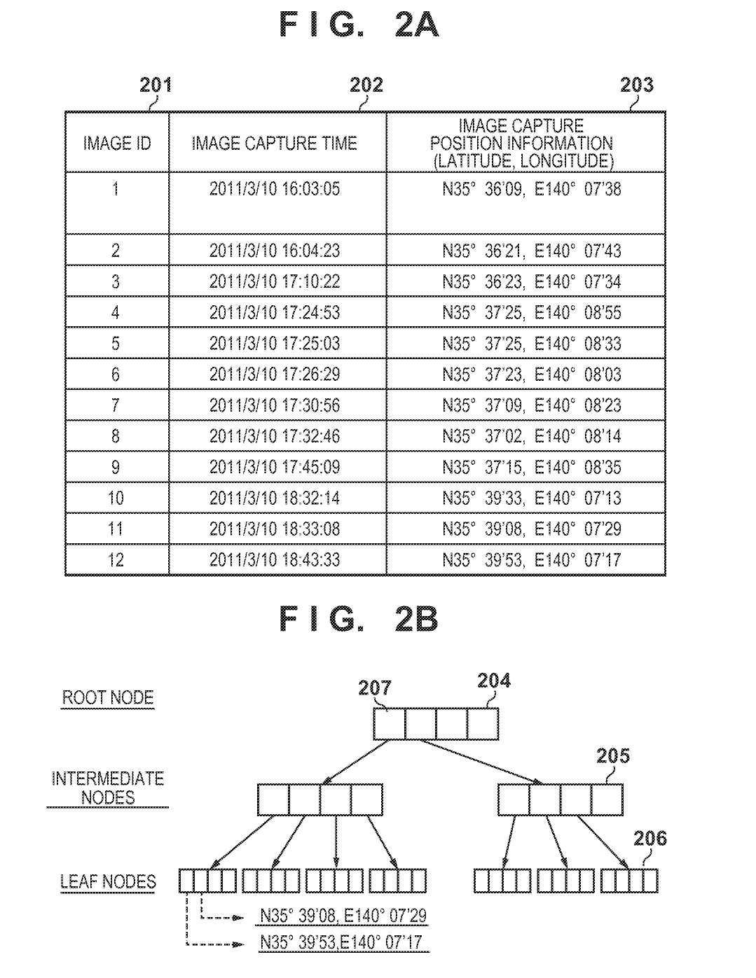

FIG. 2A is a diagram illustrating the configuration of the image management table 111.

The image management table 111 stores image IDs 201 that uniquely identify the captured images 109, as well as image capture times 202 and image capture position information 203 that serve as the metadata added when the images are captured. The image capture position information 203 can be considered spatial data, and constructs the image capture position index 112.

Although the latitude/longitude are stored as the image capture position information 203 in the first embodiment, the elevation may also be added thereto. In such a case, a search can be carried out on captured images 109 that have been captured in places where the height changes, such as skyscrapers or mountains, having specified a position of elevation. Alternatively, parameters aside from elevation, such as a shooting angle, may be added in order to employ higher-dimension information as the spatial data (configured of points or spatial regions). In this case, captured images 109 that have similar capturing subjects, as opposed to only the capture locations, can be searched.

Furthermore, although image data is stored in the image management table 111 in the first embodiment, moving picture data may be stored. In the case of moving picture data, the image capture position information 203 may be linear data in which multiple capture locations are strung together. In this case, even when moving pictures are being captured while traveling over long distances, searches can be carried out taking the travel route into consideration.

FIG. 2B is a schematic diagram illustrating the data structure of the image capture position index 112.

The image capture position index 112 forms a tree structure, and includes a root node 204, intermediate nodes 205, and leaf nodes 206. Meanwhile, each node holds a plurality of entries 207. The maximum number of entries 207 that can be stored in a single node is defined by the system. In the first embodiment, the maximum number of entries 207 is 4.

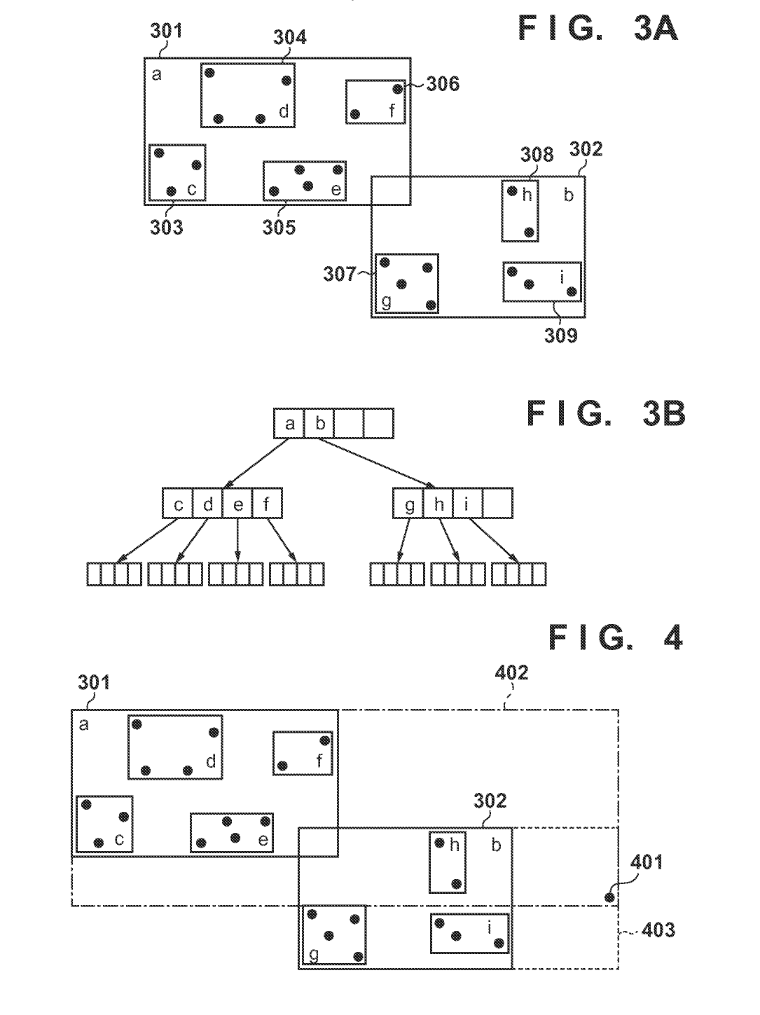

FIGS. 3A and 3B are schematic diagrams illustrating a specific example of the image capture position index 112.

Like the conventional R-Tree, the image capture position index 112 divides a multidimensional space into hierarchical partial spatial regions. Here, each partial spatial region is represented as an MBR (Minimum Bounding Rectangle), which is a region that contains the entries 207 in a given node. In the first embodiment, the entire space is divided into partial spatial regions indicated by MBR 301 and MBR 302, and the coordinate information of the respective regions is stored as the entries 207 of the root node 204. Furthermore, recursive division is carried out so that the region indicated by MBR 301 is divided into partial regions indicated by MBR 303 to MBR 306 and the region indicated by MBR 302 is divided into partial regions indicated by MBR 307 to MBR 309. The regions that are lowest in the hierarchical structure in the partial spatial regions correspond to the leaf nodes 206.

The entries 207 of the leaf nodes 206 hold the following data.
link information linking to spatial data
MBR coordinate values of spatial data

The entries 207 of the intermediate nodes and the entries 207 of the root node hold the following data.
link information linking to child nodes
MBR coordinate values including all entries 207 in child nodes

Note that in FIGS. 3A and 3B, the MBRs of the spatial data are not shown in order to simplify the diagrams.

FIG. 4 illustrates a case in which new spatial data 401 has been registered in the image capture position index 112 shown in FIG. 3A. In this case, it is necessary to enlarge an existing partial spatial region to contain the spatial data 401 that has been added. The basic processing flow used here is the same as with a conventional R-Tree. First, the index tree is searched in order from the root node 204. Then, the leaf node 206 in which to store the new data is selected by following the entries 207 in single nodes that will require the minimum amount of enlargement of the partial spatial regions (=MBR) when the spatial data 401 is stored.

In the example shown in FIG. 4, first, enlargement values are calculated for the MBR 301 and the MBR 302 that correspond to two entries within the root node 204, assuming a case where the spatial data 401 has been stored. In the case where the spatial data 401 is stored, it is necessary to enlarge the MBR 301 to an MBR 402 and to enlarge the MBR 302 to an MBR 403. In the first embodiment, the enlargement of the MBR 302 is smaller, and thus the child nodes of the MBR 302 are searched next.

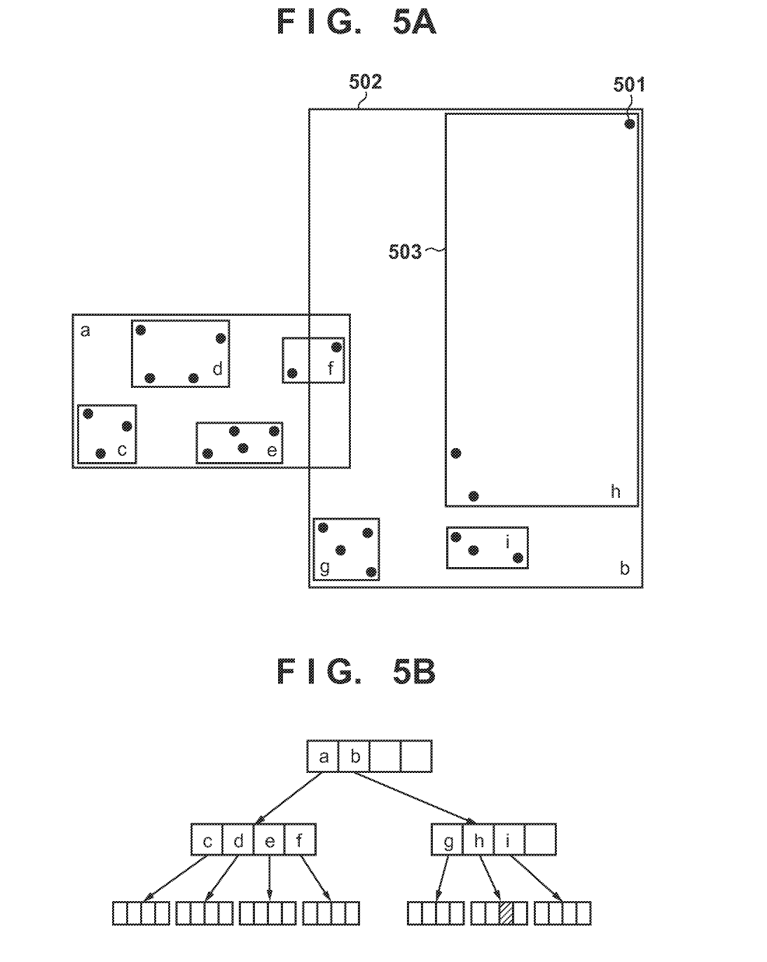

FIGS. 5A and 5B illustrate a state following the registration of spatial data 501 in the image capture position index 112 shown in FIG. 3A according to a conventional R-Tree algorithm. In particular, FIG. 5B uses hatching to illustrate the storage location of the spatial data 501.

In the conventional example illustrated in FIGS. 5A and 5B, the partial spatial regions represented by an MBR 502 and an MBR 503 are greatly enlarged, and as a result, many empty regions are present within the partial spatial regions. In this case, when a search is carried out on a space that corresponds to an empty region, it cannot be determined that spatial data corresponding to a search result is not present unless the leaf nodes 206 within the index are reached. In this manner, adding an empty region increases unnecessary searches within the index, and is a cause of a decrease in the search performance.

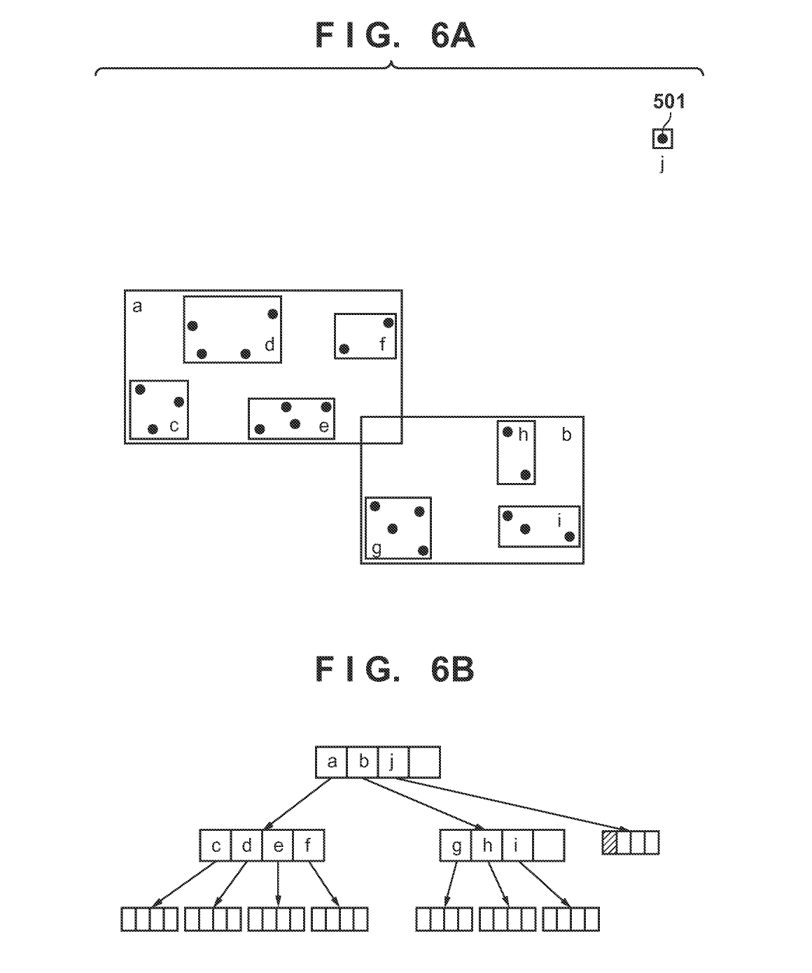

FIGS. 6A and 6B illustrate a state following the registration of the spatial data 501 in the image capture position index 112 shown in FIGS. 3A and 3B according to the first embodiment. In particular, FIG. 6B uses hatching to illustrate the storage location of the spatial data 501.

In the first embodiment, in the case where the amount by which a partial spatial region is enlarged is greater than or equal to a set amount, the spatial data 501 is managed as a partial spatial region that is separate from the existing partial spatial regions. Accordingly, in the first embodiment, the existing partial spatial regions are not enlarged more than is necessary, which makes it possible to suppress an increase in empty regions and efficiently search through the tree.

Hereinafter, the processes of the first embodiment will be described using flowcharts.

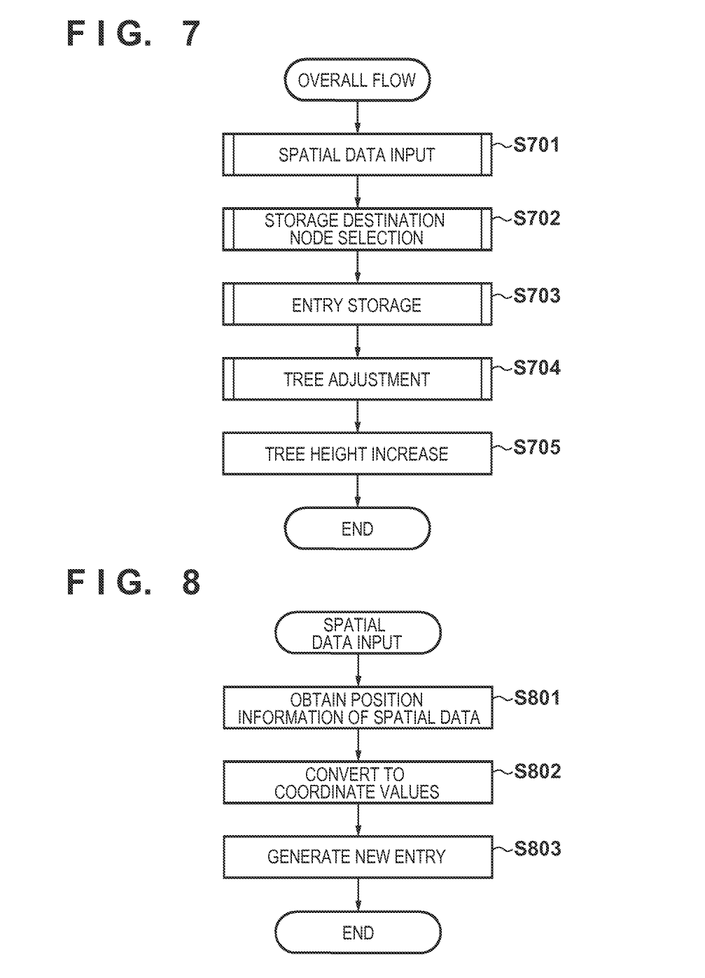

FIG. 7 is a flowchart illustrating a registration process of the data registration unit 114 according to the first embodiment.

In step S701, new spatial data is inputted to the image capture position index 112, and index entries 207 are generated from the spatial data (a spatial data input step). In step S702, the image capture position index 112 is searched, and a node that serves as the storage destination for the entries 207 is selected. Next, in step S703, the entries 207 are stored within the node selected in step S702. If necessary, processes such as dividing the node due to overflow are also carried out in this step. In step S704, due to the addition of the entries 207, the tree is reconstructed to the highest level of the hierarchy. If it is necessary to increase the height of the tree due to node division or the tree reconstruction, that process is carried out in step S705. Specifically, in step S705, in the case where it is necessary to divide the root node 204, the height of the tree is increased by 1 by generating a new root node 204 and using the two nodes resulting from the division as child nodes of the new root node 204.

FIG. 8 is a flowchart illustrating details of the process of step S701.

In step S801, position information of the inputted spatial data is obtained. Specifically, the image capture position information 203 appended to the captured image 109 is obtained. In step S802, the image capture position information 203 obtained in step S801 is converted into a rectangular coordinate system (x coordinate, y coordinate) in the multidimensional index. In step S803, a new entry is generated using the coordinate values calculated in step S802. The entry created here is an entry in the leaf node 206, and therefore holds link information linking to spatial data and MBR coordinate values of the spatial data. This entry is called a new registration entry E.

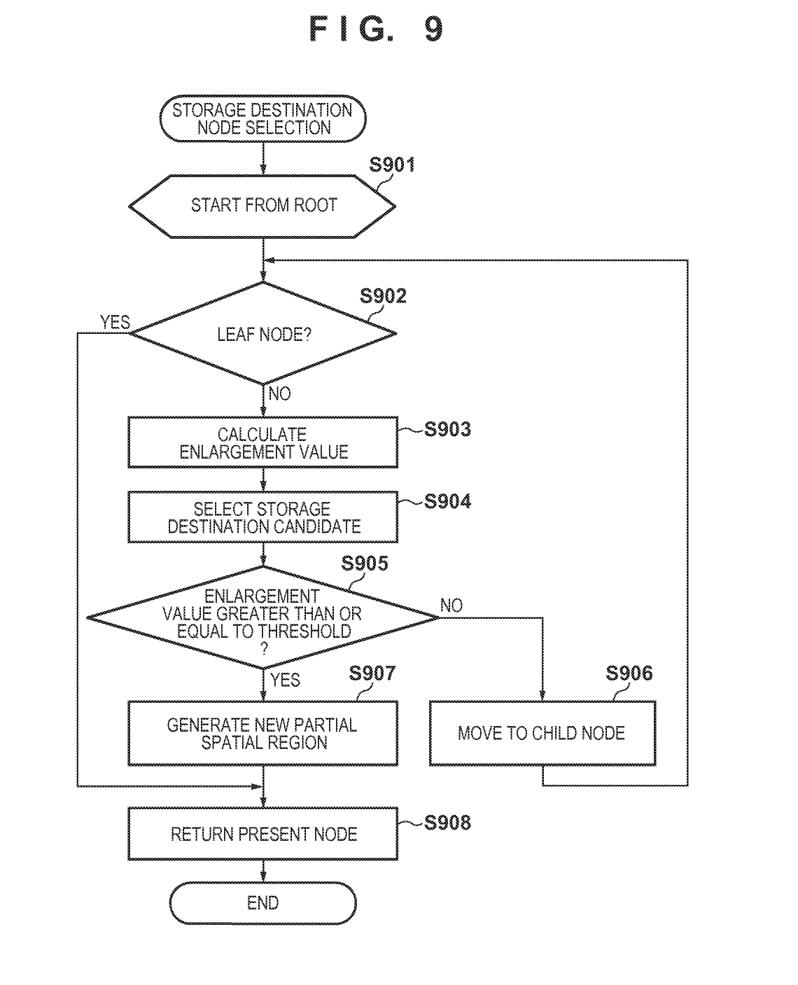

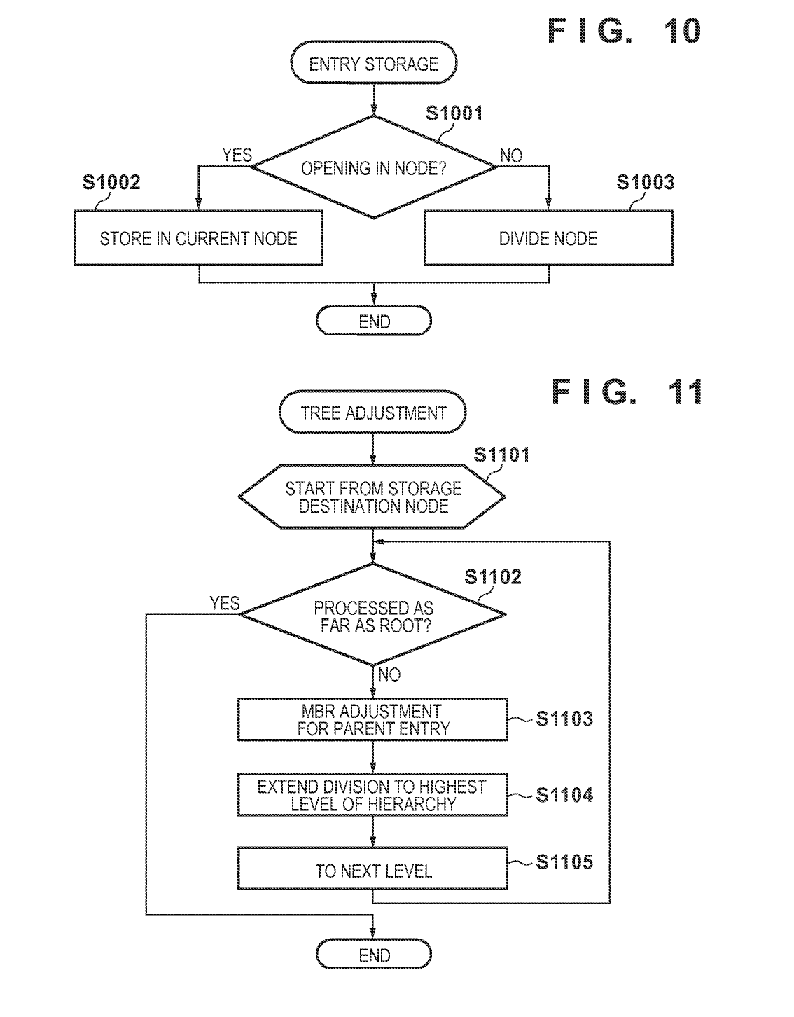

FIG. 9 is a flowchart illustrating details of the process of step S702.

In step S901, a node N that is the destination of the search is set as the root node 204. In step S902, it is determined whether or not the node N that is the destination of the search is a leaf node 206. In the case where the node N that is the destination of the search is a leaf node 206 (YES in step S902), the process advances to step S908. On the other hand, in the case where the node N that is the destination of the search is not a leaf node 206 (NO in step S902), the process advances to step S903.

In step S903, enlargement values are calculated for the MBRs held by each entry in the node N that is the destination of the search, for the case where the new registration entry E has been stored (an enlargement value calculation step). The difference or ratio between the area of the MBR after the new registration entry E has been stored and the area of the MBR before the new registration entry E has been stored can be used as the enlargement value. The area difference or area ratio between the MBRs before and after the new registration entry E has been stored can be taken as an increase amount or an increase rate of empty regions in the partial spatial region caused by the storage of the new registration entry E.

Therefore, according to this configuration, the increase amounts or increase rates of empty regions occurring when the new registration entry E is added to respective entries can be compared to each other using the enlargement values calculated in step S903. Note that in the case where a space having three dimensions or more is used, the difference or ratio between the volume of the MBR after the new registration entry E has been stored and the volume of the MBR before the new registration entry E has been stored can be used as the enlargement value. According to this configuration, the increase amounts or increase rates of empty regions (spaces) occurring in a multidimensional space when the new registration entry E is added to respective entries can be compared to each other using the enlargement values calculated in step S903.

In step S904, a storage destination candidate is selected from among the entries in the node N that is the destination of the search (a storage destination candidate selection step). In step S904, the entry in which the enlargement value calculated in step S903 is the lowest is selected as the storage destination candidate. As described earlier, because the enlargement value calculated in step S903 represents the increase amount or increase rate of empty regions in the partial spatial region caused by the storage of the new registration entry E, selecting the entry for which the enlargement value is the lowest makes it possible to ensure a relatively lower increase in the empty regions. Note that instead of calculating the entry for which the partial spatial region enlargement value is the lowest from among all entries in the node N that is the destination of the search, it is also possible to reduce the calculation time by calculating the entry that has the lowest enlargement value from among several of the entries within the node N that is the destination of the search and taking that entry as the storage destination candidate.

In step S905, it is determined whether or not the enlargement value for the storage destination candidate entry selected in step S904 is greater than or equal to a threshold. In the case where the enlargement value is less than the threshold (NO in step S905), it is determined that a child node linked from the storage destination candidate entry is suitable as a storage destination, and the process advances to step S906. In step S906, the child node linked from the storage destination candidate entry is set as the next node N that is to be searched, and the processing is repeated from step S902.

On the other hand, in the case where the enlargement value is greater than or equal to the threshold in step S905 (YES in step S905), it is determined that the empty regions will greatly increase regardless of which node the new registration entry E is stored in, and the process advances to step S907. In step S907, a new MBR that contains the new registration entry E is generated (a new partial spatial region generation step). Here, as shown in FIGS. 6A and 6B, a new node NN is generated and the new registration entry E is stored therein in order to manage the new registration entry E as a separate node. Furthermore, in order to store the new node NN in a parent node, an entry EE is generated in an intermediate node. Specifically, an MBR that contains all of the entries in the new node NN is generated, and link information linking to NN and coordinate information of the generated MBR is stored in the entry EE in the intermediate node. The new registration entry E is then replaced with the entry EE in the intermediate node. In step S908, the node N is returned as the node into which the new registration entry E is inserted.

Instead of being a fixed value configured by the system, it should be noted that the threshold used in step S905 may be changed as appropriate based on a maximum value or an average value of the partial spatial regions within the multidimensional index. According to this configuration, the threshold can be configured in accordance with the size of the current partial spatial region, which makes it possible to avoid a problem in which the threshold is too low for the size of the partial spatial region. Accordingly, it is possible to avoid an extreme increase in the number of nodes caused by the prolific generation of new partial spatial regions due to the threshold value being too low.

Furthermore, although it is determined in step S905 whether or not to generate a new partial spatial region based on the enlargement value of the partial spatial regions, place name information may also be used as the basis for the determination. For example, the configuration can also be such that in the case where the user has registered landmark information such as his or her home, workplace, or the like in the system, spatial data that is located in the vicinity thereof is stored in a new partial spatial region when such spatial data is first inputted. According to this configuration, spatial data in the vicinity of a user-registered landmark for which it is highly likely that many pieces of spatial data will be generated can be corrected so as to be collected into a different partial spatial region then other spatial data groups, which makes it possible to optimize the construction of the partial spatial regions.

FIG. 10 is a flowchart illustrating details of the process of step S703.

This flow performs a process for storing the new registration entry E in the node N selected in step S702. First, in step S1001, it is determined whether or not there is an empty entry within the node N. In the case where there is an empty entry (YES in step S1001), the process advances to step S1002, and the new registration entry E is stored in the node N. However, in the case where there is no empty entry within the node N (NO in step S1001), the process advances to step S1003, and the node N is divided into two nodes. A method that selects a division location so that the overlap between the post-division MBRs is at a minimum, which is the same as a conventional R-Tree, can be employed as an example of the method for dividing the node.

FIG. 11 is a flowchart illustrating details of the process of step S704.

In step S1101, the node N in which the new registration entry E was stored in step S703 is set as a node to be processed. In the case where the node N was divided, the two post-division nodes are taken as the nodes to be processed. In step S1102, it is determined whether or not the processing of this flow has been completed up to the root node 204. In the case where the processing has been completed up to the root node 204 (YES in step S1102), the present flow ends. However, in the case where the processing has not been completed up to the root node 204 (NO in step S1102), the process advances to step S1103.

In step S1103, the information of the MBR held by the parent entry in the node N is updated. This reflects an enlargement in the MBR caused by the storage of the new registration entry E, or a change in the MBR due to node division. In step S1104, the division is extended to the highest level of the hierarchy. Specifically, the node that was newly generated through the division process performed in step S1003 is stored as a parent node of the node N. Here, in the case where there are no empty spaces in the parent node, the parent node is divided by carrying out the same process as that in step S1003. In step S1105, the parent node of the current node N is moved upward in the hierarchy by setting that parent node as the new node N. The processing is then repeated from step S1102.

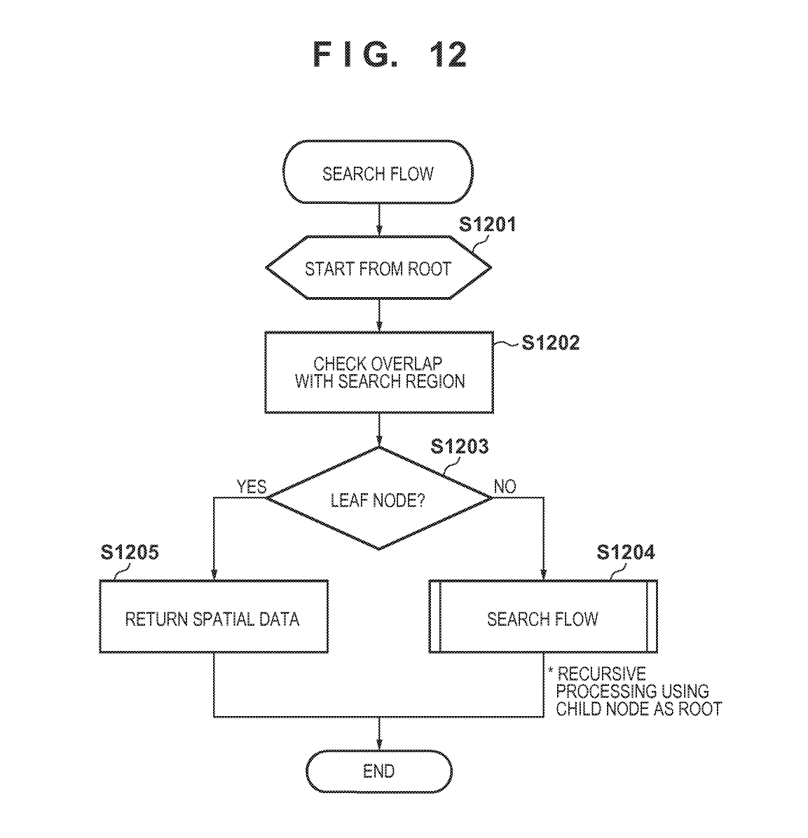

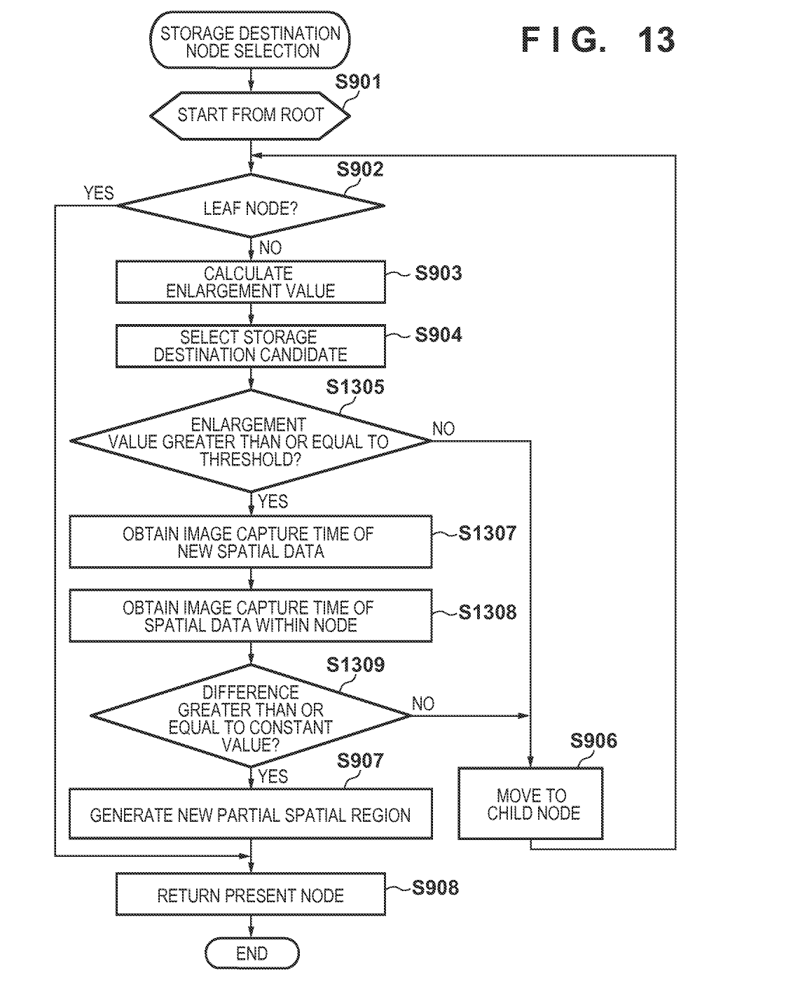

FIG. 12 is a flowchart illustrating a search process executed by the search execution unit 115 according to the first embodiment.

In this flow, spatial data present within a search region S specified by the user is searched. First, in step S1201, the root node 204 is set as a node T to be processed. In step S1202, it is determined, for the MBRs of all entries in the node T, whether or not those regions overlap with the search region S. In step S1203, it is determined whether or not the node T is a leaf node 206. In the case where the node T is a leaf node 206 (YES in step S1203), the process advances to step S1205. In step S1205, spatial data linked from the entry determined in step S1202 to overlap with the search region S is returned as a search result, and the processing ends. However, in the case where node T is not a leaf node 206 (NO in step S1203), the process advances to step S1204. In step S1204, the present flows recursively executed on a partial tree that takes, as its root node, the child node linked from the entry determined to overlap with the search region S.

With the present method, empty regions within the partial spatial regions are eliminated through the aforementioned registration process (FIG. 7), and thus the number of entries that overlap with the search region S in step S1202 is reduced more than in a conventional R-Tree. For this reason, the partial tree that is the target of the recursive processing in step S1204 is reduced compared to the conventional R-Tree, which makes it possible to shorten the search time.

Although the first embodiment has a configuration in which the image capture position information 203 of all of the data is managed using the single image capture position index 112, it should be noted that the image capture position information 203 may be managed using a plurality of image capture position indexes 112. In this case, the configuration can be such that the number of image capture position indexes 112 is increased by one when the empty regions within the partial spatial regions increase, and the nodes corresponding to new partial spatial regions are stored in the new index. According to this configuration, each index is kept as a balanced tree, which makes it possible to simplify the search process. Furthermore, by storing each index as a separate file, the file size for each index can be reduced.

Furthermore, although the first embodiment gives R-Tree as an example of the multidimensional index system used as a base, the present technique is not limited to being applied to R-Trees. It is also possible to apply the technique broadly to multidimensional index systems that divide a multidimensional space into partial spatial regions, such as R*-Tree or SR-Tree.

As described thus far, according to the first embodiment, a new partial spatial region that stores spatial data is generated in the case where the enlargement value of a partial spatial region corresponding to an index node will be greater than or equal to a threshold when the spatial data is registered, thus reducing empty regions within the partial spatial region. According to this configuration, even in the case where a small number of spatial data are present in a location that is distant from other spatial data groups, the number of empty regions can be reduced compared to the conventional techniques, which makes it possible to reduce the number of node searches when performing a search. Search performance is particularly improved for data collections that have spatial distribution characteristics, such as photograph data.

### Second Embodiment

Hereinafter, a second embodiment of the present invention will be described. Note that descriptions of constituent elements identical to those in the first embodiment will be omitted.

The first embodiment is configured to reduce empty regions within the partial spatial region of a node by generating a new partial spatial region in the case where the enlargement value of a partial spatial region corresponding to a node within the index will be greater than or equal to a threshold.

However, in the case where photograph data is used as the spatial data, it is necessary to consider not only the capture location, but also information indicating the image capture time. For example, despite the capture locations of two pieces of photograph data being distanced from each other, in the case where the difference between image capture times is low, it can be determined that the two image capture points can be moved between in a short amount of time, and furthermore, that the user is moving while capturing images. In this case, it is highly likely that the user will move and capture an image in a short amount of time at an intermediate point between the two stated points, and it is therefore not very necessary to store the two image capture points in separate partial spatial regions.

Accordingly, the second embodiment describes a configuration that takes into consideration time information added to the spatial data in addition to the enlargement values of the partial spatial regions, and determines whether or not to generate a new partial spatial region, thus suppressing the generation of unnecessary new partial spatial regions. In particular, in the second embodiment, the process for selecting the storage destination node as shown in step S702 of FIG. 7 and described in the first embodiment is executed as shown in FIG. 13.

FIG. 13 is a flowchart illustrating details of the process of step S702 in the second embodiment.

Note that processes identical to those shown in FIG. 9 and described in the first embodiment are assigned the same step numbers, and descriptions thereof will be omitted.

After the processes of step S901 to step S904, in step S1305, it is determined whether or not the enlargement value for the storage destination candidate entry selected in step S904 is greater than or equal to a threshold. In the case where the enlargement value is less than the threshold (NO in step S1305), it is determined that a child node linked from the storage destination candidate entry is suitable as a storage destination, and the process advances to step S906. In step S906, the child node linked from the storage destination candidate entry is set as the next node N that is to be searched, and the processing is repeated from step S902.

On the other hand, in the case where the enlargement value is greater than or equal to the threshold in step S1305 (YES in step S1305), it is determined that the empty regions will greatly increase regardless of which node the new registration entry E is stored in, and the process advances to step S1307.

In step S1307, the image capture time 202 (first time information) of the spatial data linked to from the new registration entry E is obtained (a first time information acquisition step). In step S1308, the image capture time 202 (second time information) of the spatial data that can be following from the storage destination candidate entry 207 is obtained (a second time information acquisition step). Here, the image capture time 202 of the corresponding spatial data can be obtained from the image management table 111 after following the multidimensional index to the leaf node 206 and obtaining the spatial data. Alternatively, the configuration may be such that the image capture time 202 of spatial data that can be followed from an entry 207 in an intermediate node is copied into and held in that entry 207. In this case, the image capture time 202 of the spatial data can be obtained without following the multidimensional index to the leaf nodes 206.

Note that in the case where a plurality of spatial data that can be followed from the storage destination candidate entry 207 is present, it is desirable to use the newest value among the obtained image capture times 202. This is because normally, new spatial data is data that has been captured after the spatial data below the storage destination candidate entry 207, and thus the image capture time difference from the newest spatial data within the partial spatial region is necessary in order to take the movement time between partial spatial regions into consideration.

In step S1309, it is determined whether or not the difference between the two image capture times 202 obtained in step S1307 and step S1308 is greater than or equal to a set value. In the case where the difference between the image capture times 202 is less than the set value (NO in step S1309), it can be determined that the space between the points in which the two pieces of spatial data are present can be moved between in a short amount of time. In this case, it is highly likely that new spatial data between the points in which the two pieces of spatial data are present will be generated in the near future, and thus it is not very necessary to store the two pieces of spatial data in separate partial spatial regions. Accordingly, it is determined that the child node linked to from the storage destination candidate entry is suitable as a storage destination, and the process advances to step S906. On the other hand, in the case where the difference between the image capture times 202 is greater than or equal to the set value (YES in step S1309), the process advances to step S907.

As described thus far, according to the second embodiment, it is possible to determine whether or not to generate a new partial spatial region taking into consideration the time information added to the spatial data in addition to the enlargement values of the partial spatial regions. Unlike the first embodiment, a new partial spatial region is not generated in the case where it has been determined that the region can be traversed in a short amount of time, and the data is stored in the same node, even in the case where the partial spatial region is greatly enlarged. According to this configuration, the generation of unnecessary new partial spatial regions can be suppressed, which makes it possible to reduce an increase in the index size caused by an increase in the number of nodes.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e. g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-028859, filed on Feb. 13, 2012 which is hereby incorporated by reference herein in its entirety.

What is claimed is:

1. An information processing apparatus that executes a multidimensional indexing process that divides a multidimensional space into partial spatial regions, stores the partial spatial regions in nodes, and when registering spatial data, enlarges the partial spatial regions to contain the spatial data, the apparatus comprising:
an input unit configured to input spatial data configured of points or spatial regions into a multidimensional index that is constructed within a storage apparatus;
a calculation unit configured to calculate enlargement values, for one or more partial spatial regions in the nodes of the multidimensional index, for the case where the spatial data is stored;
a selection unit configured to select, from among the partial spatial regions whose enlargement values have been calculated by the calculation unit, a partial spatial region to serve as a storage destination candidate of the spatial data; and
a generation unit configured to generate a new partial spatial region that contains at least the spatial data in the case where the enlargement value for the storage destination candidate partial spatial region selected by the selection unit is greater than or equal to a threshold.

2. The information processing apparatus according to claim 1,
wherein the selection unit is configured to use, as the storage destination candidate, the partial spatial region whose enlargement value calculated by the calculation unit is the lowest.

3. The information processing apparatus according to claim 1,
wherein the threshold is set based on a maximum value or an average value of the partial spatial regions in the multidimensional index.

4. The information processing apparatus according to claim 1,
wherein the enlargement value is represented as a difference or a ratio between the area of the partial spatial region after the spatial data has been stored and the area of the partial spatial region before the spatial data has been stored.

5. The information processing apparatus according to claim 1,
wherein the enlargement value is represented as a difference or a ratio between the volume of the partial spatial region after the spatial data has been stored and the volume of the partial spatial region before the spatial data has been stored.

6. The information processing apparatus according to claim 1, further comprising:
a first time information acquisition unit configured to acquire first time information added to the spatial data; and
a second time information acquisition unit configured to acquire the second time information for one or more pieces of spatial data in the nodes of the multidimensional index,
wherein the generation unit generates a new partial spatial region that contains at least the spatial data in the case where the enlargement value is greater than or equal to the threshold and the difference between the first time information and the second time information is greater than or equal to a set value.

7. A control method for an information processing apparatus that executes a multidimensional indexing process that divides a multidimensional space into partial spatial regions, stores the partial spatial regions in nodes, and when registering spatial data, enlarges the partial spatial regions to contain the spatial data, the method comprising:
an input step of an input unit inputting spatial data configured of points or spatial regions into the multidimensional index that is constructed within a storage apparatus;
a calculation step of a calculation unit calculating enlargement values, for one or more partial spatial regions in the nodes of the multidimensional index, for the case where the spatial data is stored;
a selection step of a selection unit selecting, from among the partial spatial regions whose enlargement values have been calculated in the calculation step, a partial spatial region to serve as a storage destination candidate of the spatial data; and
a generation step of a generation unit generating a new partial spatial region that contains at least the spatial data in the case where the enlargement value for the storage destination candidate partial spatial region selected in the selection step is greater than or equal to a threshold.

8. A computer-readable storage medium in which is stored a program that causes a computer to implement control of an information processing apparatus that executes a multidimensional indexing process that divides a multidimensional space into partial spatial regions, stores the partial spatial regions in nodes, and when registering spatial data, enlarges the partial spatial regions to contain the spatial data, the program causing a computer to function as:
an input unit configured to input spatial data configured of points or spatial regions into the multidimensional index that is constructed within a storage apparatus;
a calculation unit configured to calculate enlargement values, for one or more partial spatial regions in the nodes of the multidimensional index, for the case where the spatial data is stored;
a selection unit configured to select, from among the partial spatial regions whose enlargement values have been calculated by the calculation unit, a partial spatial region to serve as a storage destination candidate of the spatial data; and
a generation unit configured to generate a new partial spatial region that contains at least the spatial data in the case where the enlargement value for the storage destination candidate partial spatial region selected by the selection unit is greater than or equal to a threshold.

9. An information processing apparatus that executes a multidimensional indexing process that divides a multidimensional space into partial spatial regions, associates the partial spatial regions with nodes in a multidimensional index, and when registering spatial data, enlarges the partial spatial regions corresponding to the nodes so as to contain the spatial data, the apparatus comprising:
an input unit configured to input spatial data configured of points or spatial regions into the multidimensional index that is constructed within a storage apparatus;
an acquisition unit configured to acquire an enlargement value of the partial spatial region in the case where the inputted spatial data is registered in the node of the multidimensional index corresponding to the partial spatial region; and
a registration unit configured to generate a new node corresponding to a new partial spatial region that contains at least the spatial data and register the spatial data in the new node in the case where the magnitude of the enlargement value is greater than a threshold.

10. The information processing apparatus according to claim 9,
wherein the enlargement values of one or more partial spatial regions are obtained by the acquisition unit and the partial spatial region having the lowest enlargement value is used as a registration destination candidate.

11. The information processing apparatus according to claim 9,
wherein the threshold is set based on a maximum value or an average value of the partial spatial regions in the multidimensional index.

12. The information processing apparatus according to claim 9,
wherein the enlargement value is represented as a difference or a ratio between the area of the partial spatial region after the spatial data has been registered and the area of the partial spatial region before the spatial data has been registered.

13. The information processing apparatus according to claim 9,
wherein the enlargement value is the area of the partial spatial region after the spatial data has been registered.

14. The information processing apparatus according to claim 9, further comprising:
a designation unit configured to designate a search region for the spatial data;
a determination unit configured to determine whether or not the search region and the partial spatial region overlap; and
a search unit configured to search for a node corresponding to the partial spatial region determined by the determination unit to overlap.

15. The information processing apparatus according to claim 9,
wherein the multidimensional index is configured of hierarchically-structured nodes.

16. The information processing apparatus according to claim 9,
wherein there are cases where the partial spatial region is contained in another partial spatial region and cases where the partial spatial region is not contained in another partial spatial region.

17. The information processing apparatus according to claim 15,
wherein the hierarchical structure is a hierarchy based on the containment relationships between the partial spatial regions.

18. The information processing apparatus according to claim 14,
wherein the search unit is configured to search for the node in a plurality of hierarchies corresponding to the partial spatial region determined by the determination unit to overlap.

19. A control method for an information processing apparatus that executes a multidimensional indexing process that divides a multidimensional space into partial spatial regions, associates the partial spatial regions with nodes in a multidimensional index, and when registering spatial data, enlarges the partial spatial regions corresponding to the nodes so as to contain the spatial data, the method comprising:
an input step of inputting spatial data configured of points or spatial regions into the multidimensional index that is constructed within a storage apparatus;
an acquisition step of acquiring an enlargement value of the partial spatial region in the case where the inputted spatial data is registered in the node of the multidimensional index corresponding to the partial spatial region; and
a registration step of generating a new node corresponding to a new partial spatial region that contains at least the spatial data and registering the spatial data in the new node in the case where the magnitude of the enlargement value is greater than a threshold.

20. A computer-readable storage medium in which is stored a program that causes a computer to implement control of an information processing apparatus that executes a multidimensional indexing process that divides a multidimensional space into partial spatial regions, associates the partial spatial regions with nodes in a multidimensional index, and when registering spatial data, enlarges the partial spatial regions corresponding to the nodes so as to contain the spatial data, the program causing a computer to function as:
an input unit configured to input spatial data configured of points or spatial regions into the multidimensional index that is constructed within a storage apparatus;
an acquisition unit configured to acquire an enlargement value of the partial spatial region in the case where the inputted spatial data is registered in the node of the multidimensional index corresponding to the partial spatial region; and
a registration unit configured to generate a new node corresponding to a new partial spatial region that contains at least the spatial data and register the spatial data in the new node in the case where the magnitude of the enlargement value is greater than a threshold.
